(19) United States
(12) Patent Application Publication
(10) Pub. No.: US 2013/0154822 A1
(43) Pub. Date: Jun. 20, 2013

(54) METHOD AND SYSTEM FOR CROSS MEDIA ALARM EVENT NOTIFICATION

(71) Applicants: Vinay Kumar, Brampton (CA); Luojun Jin, Waterloo (CA); Shahid Mithani, Brampton (CA)

(72) Inventors: Vinay Kumar, Brampton (CA); Luojun Jin, Waterloo (CA); Shahid Mithani, Brampton (CA)

(73) Assignee: ROGERS COMMUNICATIONS INC., Toronto (CA)

(21) Appl. No.: 13/330,846

(22) Filed: Dec. 20, 2011

(51) Int. Cl. G08B 23/00

(52) U.S. Cl. 340/501

(57) ABSTRACT

A method for alarm event notification from a server system in relation to a premises such as a home or building. The server system acts as a centralized monitoring and notification security system for monitoring of the premises and receiving an alarm event from an on-premises monitoring system. The method includes: receiving in a server system an alarm event in relation to the premises, determining a presence status of a client application, generating a message in relation to the alarm event, and sending the message to the client application having the presence status of being present. The message may be generated to include message content which varies in dependence of capabilities of the client application having the presence status of being present.

### TECHNICAL FIELD

Example embodiments relate to the field of alarm monitoring systems for premises such as a home or building.

### BACKGROUND

When a security breach occurs at a premises, some monitoring companies typically telephone a user to notify of the breach. Some other conventional security or monitoring companies may merely use only one or a few communication mediums to notify the user such as telephone call, two-way voice channel, alternate telephone number to call, short message service (SMS) or e-mail notification. In many instances, the monitoring centre may contact a user using one particular method, and only upon failure to reach the user using that method, then contact using the next method. This may occur sequentially until the user is reached. This may lead to limited and inflexible notification methods.

A difficult with some existing systems is that some notifications may be sent to a user who may not be reachable at a particular device or service. System resources may be wasted in generating and sending unnecessary notifications or messages to those services. For example, a user may not be at home or out of wireless coverage, etc.

Additional difficulties with existing systems may be appreciated in view of the detailed description below.

### SUMMARY

Example embodiments generally relate to methods and systems for alarm event monitoring and notification in relation to a premises, which include determining a presence status of a client application, and upon determining that the client application is present, sending an alarm event message to the client application.

In accordance with an example embodiment, there is provided a method for alarm event notification. The method includes: receiving in a server system an alarm event in relation to a premises, determining a presence status of a client application, generating a message in relation to the alarm event, and sending the message to the client application having the presence status of being present.

In accordance with another example embodiment, there is provided a server system, which includes a processor, memory, and a communication subsystem for sending and receiving communications. The processor is configured for: receiving in a server system an alarm event in relation to a premises, determining a presence status of a client application, generating a message in relation to the alarm event, and sending the message to the client application having the presence status of being present.

In accordance with another example embodiment, there is provided a method for alarm event notification. The method includes: receiving in a server system an alarm event in relation to a premises, determining a presence status of each of a plurality of client applications, and sending one or more messages in relation to the alarm event, each message being sent to one or more of the client applications having the presence status of being present.

In accordance with another example embodiment, there is provided a non-transitory computer readable medium having instructions stored thereon executable by a processor for alarm event notification, the instructions comprising instructions for performing the methods.

### BRIEF DESCRIPTION OF THE DRAWINGS

Embodiments will now be described, by way of example only, with reference to the attached Figures, wherein:

FIG. 1 illustrates a block diagram of a communications system for monitoring and notification in accordance with an example embodiment;

FIG. 2 illustrates a block diagram of another example embodiment of the communications system of FIG. 1;

FIG. 3 shows, in flow diagram form, an example method for alarm event notification from a server system in accordance with an example embodiment;

FIG. 4 shows, in flow diagram form, a detailed example method for monitoring and notification from a monitoring server in accordance with an example embodiment;

FIG. 5 shows, in flow diagram form, a detailed example method for monitoring and notification from a policy server in accordance with an example embodiment;

FIG. 6 shows, in flow diagram form, a detailed example method for monitoring and notification from a notification server in accordance with an example embodiment;

FIG. 7 shows an example representation of an alarm event message, in accordance with an example embodiment;

FIG. 8 shows an example graphical user interface (GUI) for display on a device for configuration of notification settings, in accordance with an example embodiment; and

FIG. 9 shows an example graphical user interface (GUI) for display on a device for adding of a new notification setting, in accordance with an example embodiment.

Like reference numerals may be used throughout the Figures to denote similar elements and features.

### DETAILED DESCRIPTION OF EXAMPLE EMBODIMENTS

Example embodiments generally relate to methods and systems for alarm event monitoring and notification in relation to a premises, which include determining a presence status of a client application, and upon determining that the client application is present, sending an alarm event message to the client application.

In accordance with an example embodiment, there is provided a method for alarm event notification. The method includes: receiving in a server system an alarm event in relation to a premises, determining a presence status of a client application, generating a message in relation to the alarm event, and sending the message to the client application having the presence status of being present.

In accordance with another example embodiment, there is provided a server system, which includes a processor, memory, and a communication subsystem for sending and receiving communications. The processor is configured for: receiving in a server system an alarm event in relation to a premises, determining a presence status of a client application, generating a message in relation to the alarm event, and sending the message to the client application having the presence status of being present.

In accordance with another example embodiment, there is provided a method for alarm event notification. The method includes: receiving in a server system an alarm event in relation to a premises, determining a presence status of each of a plurality of client applications, and sending one or more messages in relation to the alarm event, each message being sent to one or more of the client applications having the presence status of being present.

In accordance with another example embodiment, there is provided a non-transitory computer readable medium having instructions stored thereon executable by a processor for alarm event notification, the instructions comprising instructions for performing the methods.

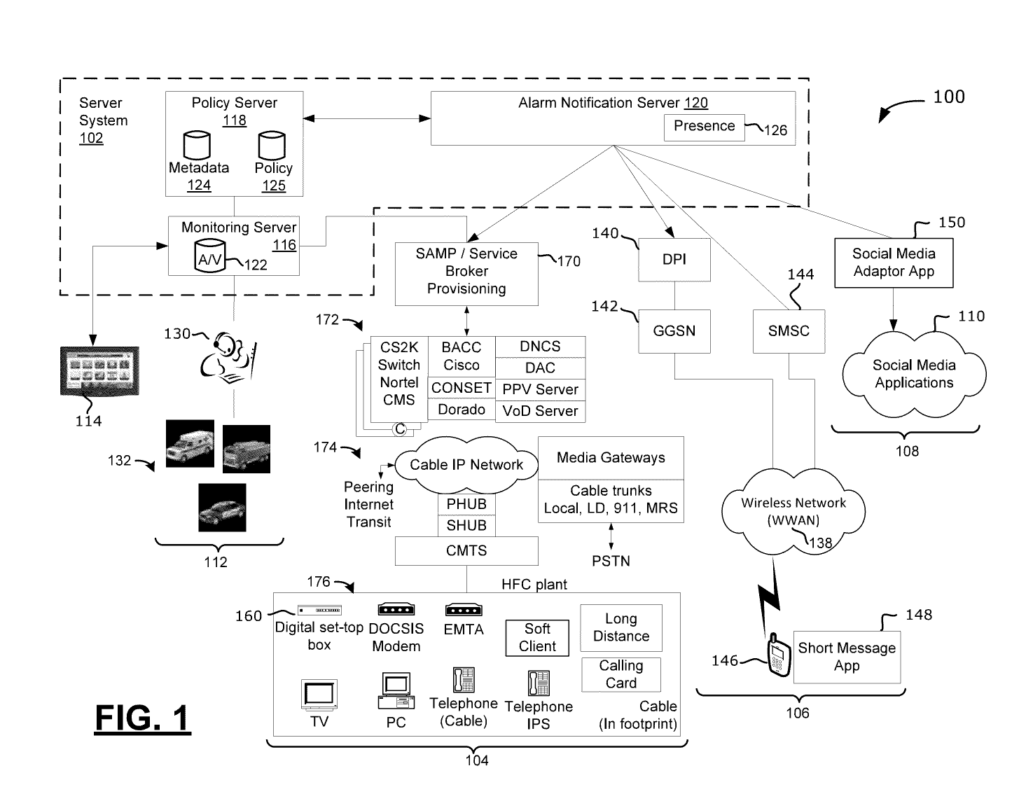

Reference is first made to FIG. 1 which shows in block diagram form a communication system 100 for monitoring and notification in accordance with an example embodiment. The communication system 100 includes a server system 102 which acts as a centralized monitoring and notification security system for monitoring of one or more premises (not shown). The server system 102 may be generally used to receive alarm event notifications from an on-premises monitoring system, subsystem, or monitoring device (not shown) in relation to the premises. In accordance with some example embodiments, a user or subscriber may have access to a number of different client applications. The server system 102 generally may be used to determine which client applications are present or active. In accordance with some example embodiments, the server system 102 generally may send alarm event messages across various different communication mediums to those present or active client applications, for example by way of a cable television network 104, a wireless communication network 106, and/or Internet based network 108 which may include social media applications 110. More than one of the client applications or client devices may be associated with a same user or subscriber. In some example embodiments, a same enterprise or company (e.g. a telecommunications provider) may control some or all of the cable television network 104, the wireless communication network 106, and/or the Internet based network 108. In some example embodiments, a user or subscriber may subscribe to some or all of these services from the same telecommunications provider.

In some example embodiments, the server system 102 may also communicate with a dispatch system 112. A computer device 114 may access a web site or a web portal to communicate with the server system 102, for example to allow a user to configure notification preferences for the various client applications. The web site or web portal may be hosted by the server system 102, or by an external server.

Referring still to FIG. 1, in some example embodiments the server system 102 may include one or more modules or servers, shown as monitoring server 116, policy sever 118, and alarm notification server 120. In some example embodiments, the monitoring server 116 may also include a media database 122 for storing media content in relation to a premises, for example as received from on-premises monitoring devices (not shown). In some example embodiments, the policy server 118 includes a metadata database 124 for storing metadata, which may include information relating to alarm events and alarm event messages. The policy server 118 includes a policy database 125 for storing policy settings in relation to alarm notification preferences for particular subscribers. In some example embodiments, the alarm notification server 120 may include a presence module 126 for determining a presence of client applications and/or client devices. Other configurations may also be used in other example embodiments, for example, combining functions or modules into less servers or splitting functions or modules into additional servers.

The cable television network 104 may generally include television content services and data services such as Data Over Cable Service Interface Specification (DOCSIS) services. In some example embodiments, the television content services are accessible using a digital television terminal, for example a digital set-top box 160. In some example embodiments, the digital set-top box 160 may include a client application agent, which may be used to communicate with the server system 102. The client application agent may be used to display messages onto a video display screen (e.g. television), for example as an overlay to existing displayed television content. Such messages may be received from the server system 102. The client application agent may be used to determine when a user or subscriber is operating the digital set-top box 160. For example, a user may be operating a digital set-top box 160 at his cottage, while an alarm event is occurring at his primary residence.

In other example embodiment, DOCSIS services may be used to determine when a user or subscriber is accessing the Internet using the cable television network 104. The DOCSIS services may be used to determine when a user or subscriber is accessing the Internet using any web-based application such as a web browser application. For example, a user may be accessing cable-based Internet while at his cottage, while an alarm event is occurring at his primary residence. Alarm event messages may, for example, be sent to the DOCSIS services by way of the user's web browser. In some example embodiments, based on receipt of the message by the server system 102, when any web page is being accessed by the user, an additional notification window may be inserted at a top of a web page screen. Other messaging services may be used to deliver the alarm event message, for example using a popup window.

Additional client devices 176 and related applications may be used by a subscriber to access the cable television network 104. For example, such client devices 176 may include a DOCSIS modem, Embedded Multimedia Terminal Adapter (EMTA), IP-based telephone (Telephone IPS), television (TV), Personal Computer (PC), and cable-based telephone.

As shown in FIG. 1, the cable television network 104 includes a server for Service Broker Provisioning 170. The cable television network 104 further includes additional servers 172, for example CS2K by Nortel Call Management Server (CMS), Broadband Access Center for Cable (BACC) by CISCO, Dorado, Digital Network Control System (DNCS), DAC, Pay-Per-View (PPV) server, and Video-On-Demand (VoD) server.

As shown in FIG. 1, the cable television network 104 includes interfaces 174 such as Peering Internet Transit, Media Gateways, Cable trunks (to the Public Switched Telephone Network (PSTN)), Primary HUB (PHUB), Secondary Hub (SHUB), cable modem termination system (CMTS), and Hybrid fiber-coaxial (HFC).

Although cable television network 104 may traditionally include merely coaxial connections or networks, it would be appreciated that the cable television network 104 may also include fiber optic connections or networks.

Referring still to FIG. 1, the wireless communication network 106 may comprise a Wireless Wide Area Network (WWAN) 138 or other suitable network arrangement. The WWAN 138 may be implemented as any suitable wireless access network technology. The WWAN 138 includes a number of transceiver base stations which provides wireless Radio Frequency (RF) coverage to a corresponding area or cell.

In some embodiments, the WWAN 138 conforms to one or more of the following wireless network types: Mobitex Radio Network, DataTAC, GSM (Global System for Mobile Communication), GPRS (General Packet Radio System), TDMA (Time Division Multiple Access), CDMA (Code Division Multiple Access), CDPD (Cellular Digital Packet Data), iDEN (integrated Digital Enhanced Network), EvDO (Evolution-Data Optimized) CDMA2000, EDGE (Enhanced Data rates for GSM Evolution), UMTS (Universal Mobile Telecommunication Systems), HSDPA (High-Speed Downlink Packet Access), IEEE 802.16e (also referred to as Worldwide Interoperability for Microwave Access or “WiMAX), or various other networks. Although WWAN 138 is described as a “Wide-Area” network, that term is intended herein also to incorporate wireless Metropolitan Area Networks (WMAN) and other similar technologies for providing coordinated service wirelessly over an area larger than that covered by typical WLANs.

As shown in FIG. 1, in some example embodiments, the wireless communication network 106 includes modules for Deep Packet Inspection (DPI) 140, Gateway GPRS Support Node (GGSN) 142, and short message service center (SMSC) 144. In some example embodiments, the wireless communication network 106 may be used to communication with a mobile communication device 146. The mobile communication device 146 may be configured to communicate using data applications and/or voice applications. For example, the mobile communication device 146 may include a short message application 148, such as a short messaging service (SMS) application and/or a multimedia messaging service (MMS) application. Messages to the short message application 148 may be sent using, for example, a phone number of the mobile communication device 146. The mobile communication device 146 may further include instant messaging applications, such as Blackberry PIN messaging, etc. The mobile communication device 146 may also be configured to access the Internet (e.g. using EDGE), and implement web-based applications. The mobile communication device 146 may be configured to implement social media applications 110.

For example, a particular network carrier or telecommunications company may use the wireless communication network 106 to detect a presence of the mobile communication device 146. For example, as understood in the art, a national network carrier may readily determine whether a particular mobile communication device 146 is enabled within a coverage area. This detection may be performed by communicating with the data and/or voice protocols of the mobile communication device 146.

Referring still to FIG. 1, examples of the social media applications 110 include Facebook™ and Twitter™. In some example embodiments, a social media adaptor application or “app” 150 may be provided to be installed by a user or subscriber. The social media app 150 may be installed within the social media application 110 to communicate with the social media application 110. In some example embodiments, the social media app 150 may be used to determine a presence of the user, for example when the user has logged into the particular social media application 110. In some example embodiments, the presence module 126 may communicate with the social media app 150 to determine whether the user is presently logged in. In some example embodiments, the notification server 120 may send specifically formatted alarm event messages to the social media application 110 using the social media app 150. For example, the notification server 120 may send a “private” message to a user's “wall” or a private “tweet” to a user of the social media application 110.

In some example embodiments, the policy database 125 stores all client devices or client applications for which a user has subscribed. The policy settings of the policy database 126 may be updated each time a user subscribes to a new telecommunications service, or removes a service. The settings for receiving alarm event notifications may be configured by the user.

In some example embodiments, the policy database 125 may store privacy settings of the subscriber. Such privacy settings may include password or other security information so as to gain access to the particular social media application 110. Some privacy settings may include contact information for each client application, such as destination recipient mailing address (for the cable television network 104), e-mail address, telephone number, etc. This information may be retrieved so as to correctly identify the destination when sending alarm event messages. The privacy settings may be updated each time a user subscribes to a new telecommunications service, or removes a service.

Referring still to FIG. 1, in some example embodiments, the Internet based network 108 may include an IPTV application (not shown) or web-based television application. The IPTV application may be used by a subscriber to watch digital on-demand television content over a web-based interface such as a web browser over the Internet. In some example embodiments, the presence module 126 may communicate with the IPTV application to determine whether the user is presently logged in (e.g. watching television content using device or computer). A message may be sent to a web browser running the IPTV application, for example using an additional notification window may be inserted at a top of a web page screen being accessed by the user. Other messaging services may be used to deliver the alarm event message, for example using a popup window.

It will be appreciated that the above-described communication system 100 is provided for the purpose of illustration only, and that the above-described communication system 100 comprises one possible communication network configuration of a multitude of possible configurations for use with the server system 102. Example embodiments may be employed in connection with any other type of network and associated client devices and client applications that are effective in implementing or facilitating communications. Suitable variations of the communication system 100 will be understood to a person of skill in the art and are intended to fall within the scope of the present example embodiments. For example, additional example implementations may include xDSL (digital subscriber line), fiber to the home (FTTH), etc.

A difficulty with some existing conventional security systems is that some messages may be sent to a user who may not be reachable at a particular client application. System resources may be wasted in generating unnecessary alarm event messages and sending messages to those client applications. For example, a user may not be at home or out of wireless coverage, etc.

In accordance with some example embodiments, there is generally provided methods for determining a presence of client applications, and generating and sending an alarm event message to those client applications which are present.

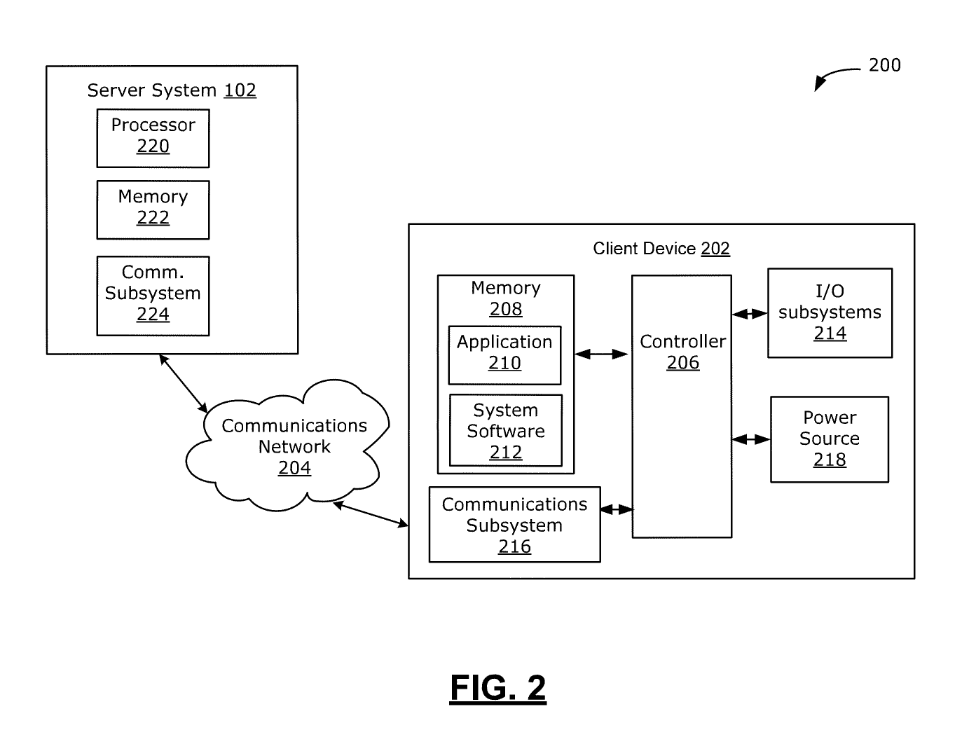

Reference is now made to FIG. 2, which shows another block diagram of a communication system 200, in accordance with another example embodiment. As shown, the server system 102 may communicate with a client device 202 over a communications network 204. The client device 202 may include one or more client applications 210. The server system 102 may select the particular communications network 120, communications medium or communications channel in dependence of the particular type of client application 210. For example, referring to FIG. 1, the server system 102 communicates with the social media application app 150 using the Internet, the digital set-top box 160 using the television network 104, and the short messaging application 148 using the wireless communication network 106, and the web-based television application (not shown) using the Internet.

Still referring to FIG. 2, in some example embodiments, the server system 102 may include one or more processors 220, at least a memory 222 for storing of system software and metadata databases, and at least a communications subsystem 224.

In some example embodiments, the client device 202 may include a controller 206 such as a microprocessor, which controls the overall operation of the client device 202. The controller 206 interacts with other device components such as memory 208, and system software 212 stored in the memory 208 for executing the applications 210, input/output subsystems 214 and a communications subsystem 216. A power source 218 powers the client device 202.

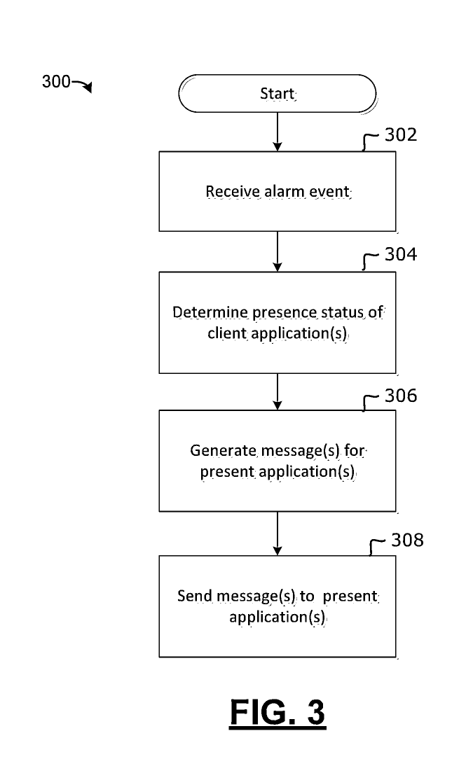

Reference is now made to FIG. 3, which shows an example method 300 for alarm event notification from the server system 102, in accordance with an example embodiment. Generally, the server system 102 may determine or detect a presence of one or more client applications 210, and send an alarm event message to a client application 210 when that client application 210 is present.

At event 302, the server system 102 receives an alarm event in relation to a premises, for example from an on-premises monitoring system or monitoring device (not shown). At event 304, the server system 102 determines a presence status of one or more client applications 210. In some example embodiments, at least some of the client applications 210 may be contacted using different communications networks 204 or channels. The particular client applications 210 to be detected may be preselected by a user. At event 306, for only those client applications 210 which have a presence status of being present, the server system 102 generates one or more alarm event messages. At event 308, the server system 102 sends one or more of the alarm event messages to one or more of the client applications 210 having the presence status of being present. In some example embodiments, the alarm event messages sent to the client applications 210 may be sent concurrently or near-concurrently, since a presence of those client applications 210 had already been established at event 304. In some example embodiments, the server system 102 may not require a receipt confirmation from a given client application 210 prior to sending an alarm event message to another client application 210.

Referring again to event 304, in some example embodiments, the determining of the presence status may include receiving the presence status from the client application 210. In some example embodiments, the determining of the presence status includes sending a request for the presence status from the client application 210. In some example embodiments, the request is merely for the presence status and thus may be sent without additional alarm information.

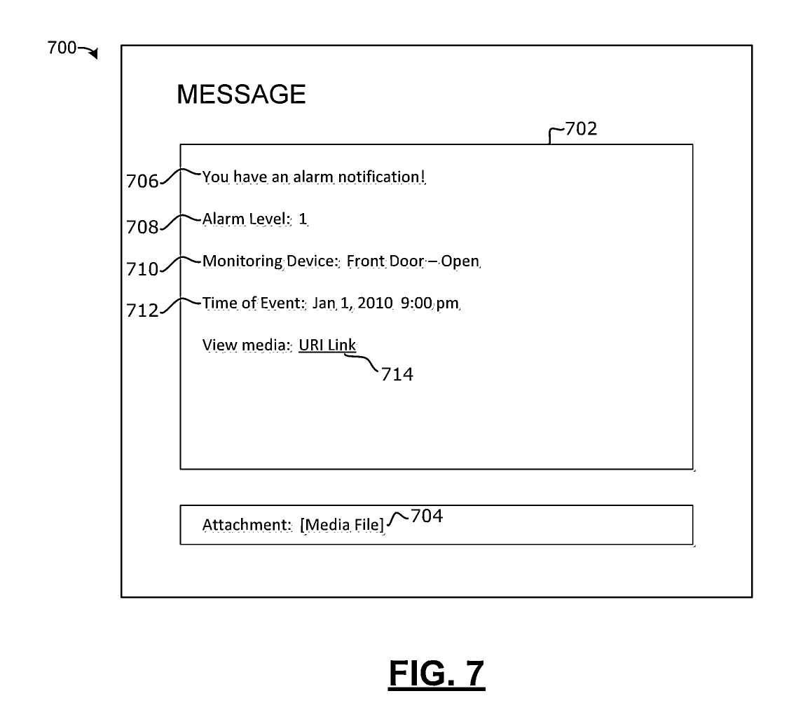

Reference is now made to FIG. 7, which shows an example alarm event message 700 in accordance with an example embodiment. One or more of the alarm event message 700 may be custom generated by the server system 102 and sent to one or more of the client application 210 over the communications network 204. By generating alarm event messages 700 for only those client applications 210 which are present, resources may be saved in avoiding the generation of unnecessary messages, and network traffic may be reduced. The alarm event messages 700 may be saved or archived in a memory or database of the server system 102. In some example embodiments, the alarm event messages 700 are tracked and logged as tracking information, and may further be used for subscriber billing purposes.

As shown in FIG. 7, the alarm event message 700 includes message content 702 (e.g. message body text) and may include media content by way of a media file 704. As shown in FIG. 7, the message content 702 can include a number of elements or fields such as an introduction 706 (e.g., “You have an alarm notification!” as shown), an alarm level 708, an identification of the on-premises monitoring device (e.g. “front door”) and alarm event (e.g. “open”) 710, a timestamp 712 (e.g. “Jan. 1, 2010 9:00 pm”), and/or an address or link 714 to media content of the premises. More or less elements or fields may be included in the message 700, and may depend on the particular destination client application 210.

In some example embodiments, each of the messages 700 are generated to include message content 702 which varies in dependence of the capabilities of those client applications 210 having the presence status of being present. For example, some client applications 210 which include a web browser application may support more or content-rich message content 702. In another example, a short message application 148 may support shorter or text-only message content 702 which may, for example, include only the introduction 706 and/or the link 714.

Referring now to the media file 704, the particular format of the included media file 704 may include video, audio, and/or images of the premises or of the on-premises monitoring device. The format of the media file 704 may also include sequential images such as animation-GIF (ANI-GIF). The format of the media file 704 may also include time-elapsed images (e.g. each image taken every time period such as 30 seconds). The particular format of the media file 704 included within the message 700 may vary in dependence of the capabilities of the client application 210. For example, referring briefly to FIG. 1, the media file 704 may include an image when sent as an MMS message to the short message application 148 of the mobile communication device 148. The media file 704 may include video when sent to a digital set-top box 160 or to a web based application. The media file 704 may also be compressed or down-scaled depending on the destination device, for example according to MPEG2, MPEG4, MJPEG etc.

Referring again to FIG. 7, in some example embodiments, the media file 704 may be a representation of the premises or an on-premises monitoring device at the time or timestamp of the alarm event. In another example, a most current representation of the premises or on-premises monitoring device may be included. In another example, a time range of the media content (video, audio, and/or images) may be included, for example within a one minute range of the timestamp of the alarm event, or for example the most recent one minute as received by the server system 102.

In some example embodiments, the media file 704 is included as an attachment to the message 700. In other example embodiments, the media file 704 is included in-line to the message 700. In some example embodiments, no media file 704 is included at all in some of the messages 700. The particular type of inclusion of the media file 704 in the message 700 may be dependant on the format that is capable of being supported by the particular destination client application 210.

Referring now to the link 714 within the message 700, this may include, for example, a uniform resource identifier (URI) of a website. The link 714 provides website access to one or more types of media content in relation to the premises. The media content may include, for example, video, audio, images and/or sequential images. The website may also include a user interface for further interaction with the client application 210, with additional media content being accessible. For example, more than one link 714 may be generated for a particular alarm event, and the link 714 relates to media content which depends on the capabilities of the particular client application 210.

In some example embodiments, the media content accessible at the website includes pre-recorded media which is recorded at the time of the alarm event. In other example embodiments, the media content accessible at the website includes present real-time media of the premises or the on-premises monitoring device.

In some example embodiments, each website is a dedicated website with an associated link 714 which is dedicated to the particular user or subscriber. In other example embodiments, each website is dynamically generated and may be accessed from a dynamically generated link 714 in relation to the particular alarm event. In some example embodiments, a website is particularly formatted in dependence of the client application 210. For example, the link 714 may be to a website which is wireless application protocol (WAP)-enabled when the message 700 is sent to the mobile communication device 146 (FIG. 1). The website may include additional features or content when the message 700 is sent to a personal computer. In other example embodiments, the website may detect the type of client device 202 or client application 210 attempting to gain access, and provide a conventional or a WAP-enabled browser interface accordingly. In some example embodiments, the link 714 may be a direct link to a media file (e.g. http://myvideo.mov). The website may be resident on the server system 102 or may be hosted by an external hosting system or service. In some example embodiments, the website is security coded and/or password or PIN (Personal Identification Number) protected.

Referring again to FIG. 1, the server system 102 will now be described in greater detail, by way of examples, and in particular exemplary functions with respect to the presence detection of client applications 210 and subsequent alarm event messages 700 sent to those client applications 210 which are present.

By way of example only, the server system 102 communicates with the social media application 110 such as Twitter™ using the Internet. A social media app 150 specific to communicating with Twitter™ may be installed. The server system 102 may determine a presence status of the social media application 110 using the social media app 150 (e.g. a user has logged in). The server system 102 sends to the social media application 110 an alarm event message 700 when it is determined that the social media application 110 is present. The alarm event message may be received as a private “tweet”. The alarm event message may only include the introduction 706 and the link 714 to media content, wherein the media content is an image.

By way of example only, the server system 102 communicates with the social media application 110 such as Facebook™ using the Internet. A social media app 150 specific to communicating with Facebook™ may be installed. The server system 102 may determine a presence status of the social media application 110 using the social media app 150 (e.g. a user has logged in). The server system 102 sends to the social media application 110 an alarm event message 700 when it is determined that the social media application 110 is present. The alarm event message may be received as a private posting on the user's “wall”. The alarm event message 700 may include the introduction 706, the alarm level 708, the identification of the on-premises monitoring device and alarm event 710, the timestamp 712, and/or the link 714 to media content, wherein the media content is an image and/or video.

By way of example only, the server system 102 communicates with the digital set-top box 160 which has the client application agent. The server system 102 may determine a presence status of the digital set-top box 160 using the client application agent. The server system 102 sends to the social media application 110 an alarm event message 700 when it is determined that the digital set-top box 160 is being used by a subscriber. For example, a user may be actively watching television, changing channels, or accessing Pay-Per-View (PPV) and/or Video-on-Demand (VoD). The alarm event message 700 may be received and displayed as an overlay to existing displayed television content. The alarm event message 700 may include the media file 704 displayed in-line to the message 700 on the screen. The alarm event message 700 may also include the introduction 706, the alarm level 708, the identification of the on-premises monitoring device and alarm event 710, and the timestamp 712. The link 714 to media content may not be included in some example embodiments, for example, as user input and navigation may be difficult using some television systems.

By way of example only, the server system 102 communicates with an SMS application (short messaging application 148). A particular network carrier or telecommunications company may use the wireless communication network 106 to detect a presence of the mobile communication device 146, for example using voice and/or data protocols. The server system 102 sends to the SMS application an alarm event message 700 when it is determined that the mobile communication device 146 is present and active within a network coverage area, which can be within a defined region (e.g. a country). The alarm event message 700 may include the introduction 706, and the link 714 to media content, wherein the media content is an image.

By way of example only, the server system 102 communicates with a MMS application of the short messaging application 148. The server system 102 sends to the MMS application an alarm event message 700 when it is determined that the mobile communication device 146 is present within a network coverage area, which can be within a defined region (e.g. a country). The alarm event message 700 may include the media file 704 in the form of an image, the introduction 706, the alarm level 708, the identification of the on-premises monitoring device and alarm event 710, the timestamp 712, and/or the link 714 to media content.

By way of example only, the server system 102 communicates with the web-based television application (not shown) using the Internet. In some example embodiments, the server system 102 may determine whether the user is presently logged in (e.g. watching web-based television content using a device or computer). The message 700 may be sent to the web browser running the application, for example an additional notification window may be inserted at a top of a web page screen being accessed by the user. Other messaging services may be used to deliver the alarm event message, for example using a popup window. The alarm event message 700 may include the media file 704 in the form of image or video, which may be in-line to the message 700. The message 700 may also include the introduction 706, the alarm level 708, the identification of the on-premises monitoring device and alarm event 710, the timestamp 712, and/or the link 714 to media content, wherein the media content includes image or video and additional user interactions. The message 700 may be content-rich, which can include Flash content, additional text formatting such as colors, bolding and/or highlighting, etc.

In some example embodiments, a user receiving the message 700 may be provided with an opportunity to reply to the message. For example, a user may reply to a received short message by responding to the phone number which had sent the short message. In some example embodiments, the reply message is sent over a same communication channel as in the originally received message 700. This reply message may then be received and processed by the server system 102. In some example embodiments, the message 700 may include a user selectable option or icon (not shown), such as a “Reply” button. Selection of the button permits the user to send a response message back to the server system 102, for example over the same communication channel. For example, the reply message may include a passcode or PIN, for example to advise that the dispatch system 112 does not need to be notified.

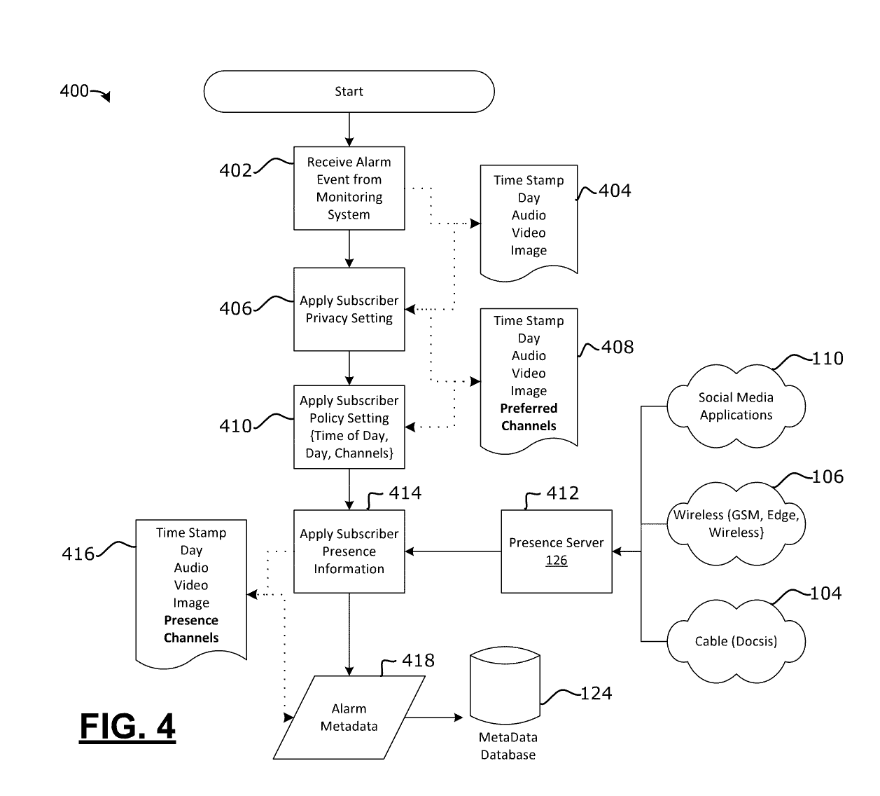

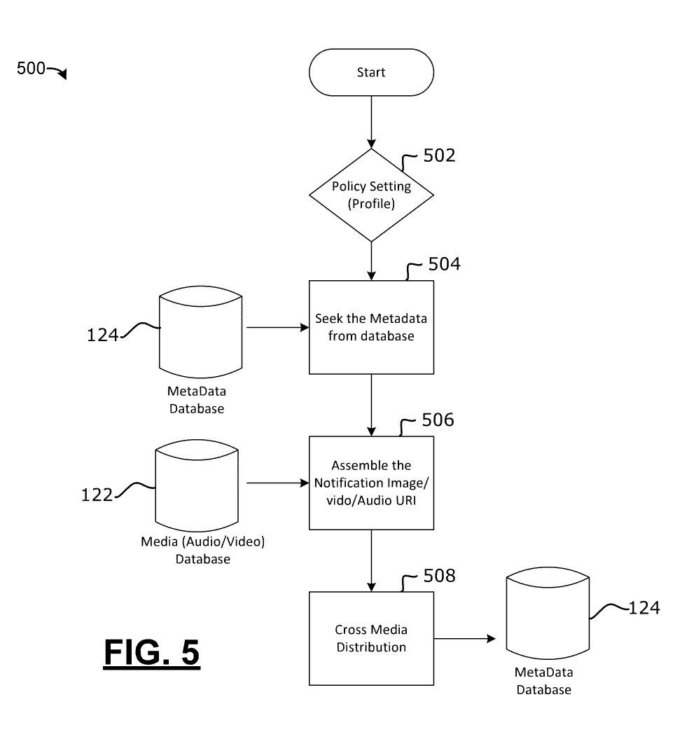

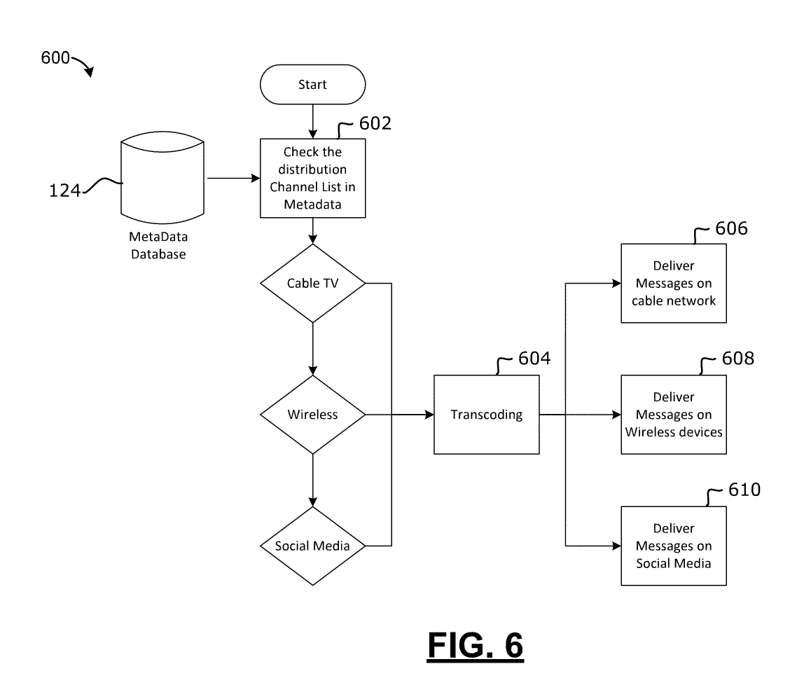

Reference is now made to FIGS. 4 to 6 which show, in flow diagram form, detailed example methods for monitoring and notification from the server system 102, in accordance with an example embodiment. FIG. 4 shows an alarm generation method 400 being generally performed from the monitoring server 116, FIG. 5 shows an alarm distribution method 500 generally performed from the policy server 118, and FIG. 6 shows a cross-media notification distribution method 600 generally performed from the notification system 120.

Referring to FIG. 4, the method 400 begins at event 402 which is receiving an alarm event from a monitoring device in relation to a premises. At event 404, an alarm event record is assembled in a memory, which can include a timestamp of the alarm event (including the date), and media content or an address or pointer to the applicable media content. The media content may include, for example, audio, video and/or images. At event 406, the monitoring server 116 applies subscriber privacy settings (e.g. obtained from policy database 125), for example subscriber security or password information to access a subscriber's Internet application such as one or more social media applications 110. At event 408, as determined from the policy database 125, the alarm event record is updated to include any preferred channels, which are those client applications 210 which are to receive alarm notifications when those client applications 210 are present. At event 410, the subscriber policy settings from policy database 125 are applied, which are those client applications 210 which are to receive alarm notifications, which can take into account time of day, day, and preferred channels. In some example embodiments, a user can edit and create the subscriber policy settings, by preselecting one or more of the client applications 210 which are to receive alarm event notifications only when present.

Referring still to FIG. 4, at event 412, depending on the policy settings, the presence server 126 determines a presence of those client applications 210 which have been preselected, for example from the social media applications 110, the wireless communication network 106, and the cable television network 104. The presence of a client application 210 may be indicated using a presence status which can indicate as “present” or “not present”. At event 414, the presence status is received by the monitoring system 116. At event 416, the alarm event record is updated to include the presence status of the client applications 210 (e.g. “presence channels”, as shown). At event 418, the alarm event record is stored into the metadata database 124.

Referring now to FIG. 5, at event 502 a particular subscriber's policy setting (from policy database 125) is determined. At event 504, an alarm event record for the particular subscriber is retrieved from the metadata database 124. At event 506, based on the “presence channels” (event 416) the policy server 118 custom assembles or generates the information or metadata for the alarm event messages, for example in the format of plain text or ASCII text at this stage. In accordance with example embodiments, these messages may be generated in dependence of each particular client application 210. The metadata for the messages may include a pointer to media content from the media database 122, wherein the media content is dependent on each particular client application 210. At event 506 the policy server 118 may further generate or cause to be generated the link 714 (FIG. 7) and generate the associated website, wherein each link 714 and the content of the website may be dependent on each particular client application 210. The website may provide access to the media content from the media database 122. At event 508, the metadata for generating the message is stored in the metadata database 124 for cross media distribution by the alarm notification server 120.

Referring now to FIG. 6, at event 602 the notification server 120 checks from the metadata database 124 the particular information or metadata to send the alarm event messages, which are to be sent to particular communication channels. The alarm event messages may be categorized or grouped based on type of communication channel. At event 604 the particular messages may be transcoded from the information metadata (e.g. plain text or ASCII text) to particular formats which are particular to the particular communications channels. At event 604, the transcoding may also include converting the source media from the media database 122 to the appropriate audio, video, or image, as suitable for the particular destination device. This may also include compressing or down-scaling depending on the destination device. This may include converting and storing converted, compressed, or down-scaled media files at the media database 122 with associated different URL links which can be accessed by different devices (i.e., different device uses different URI links to access different version of the media). The transcoding may include, for example, converting or extracting a frame of a video to an image, or for example converting or extracting audio from the video, or for example cropping an image or video. An example of such messages is the alarm event message 700, described in detail herein with respect to FIG. 7. At event 606 the messages and media are formatted which are to be sent to the cable television network 104. At event 608 the messages and media are formatted which are to be sent to the wireless communication network 106. At event 610 the messages and media are formatted which are to be sent to the social media applications 110.

Referring again to FIG. 1, in some example embodiments, the computer device 114 may be used to access a web site or web portal to configure security settings of the server system 102, for example to configure monitoring and/or alarm notification preferences. The computer device 114 may also be used to control on-premises devices (via the server system 102), for example to adjust settings of a video camera, thermostat, audible alarm, etc. The computer device 114 may also be used for receiving monitoring information from on-premises monitoring devices, for example real-time media such as video or images of the premises. The computer device 114 may, for example, be a tablet computer, a mobile phone, or general purpose device such as a personal computer. Some example embodiments may include the use of a dedicated installed application or “app” on the computer device 114.

Accordingly, the computer device 114 acts as a control device for the on-premises devices, as well as control for the provision and management of the notification services described herein. This may be performed through a web portal, with access anywhere within or external to the premises, wherever there is a suitable Internet connection.

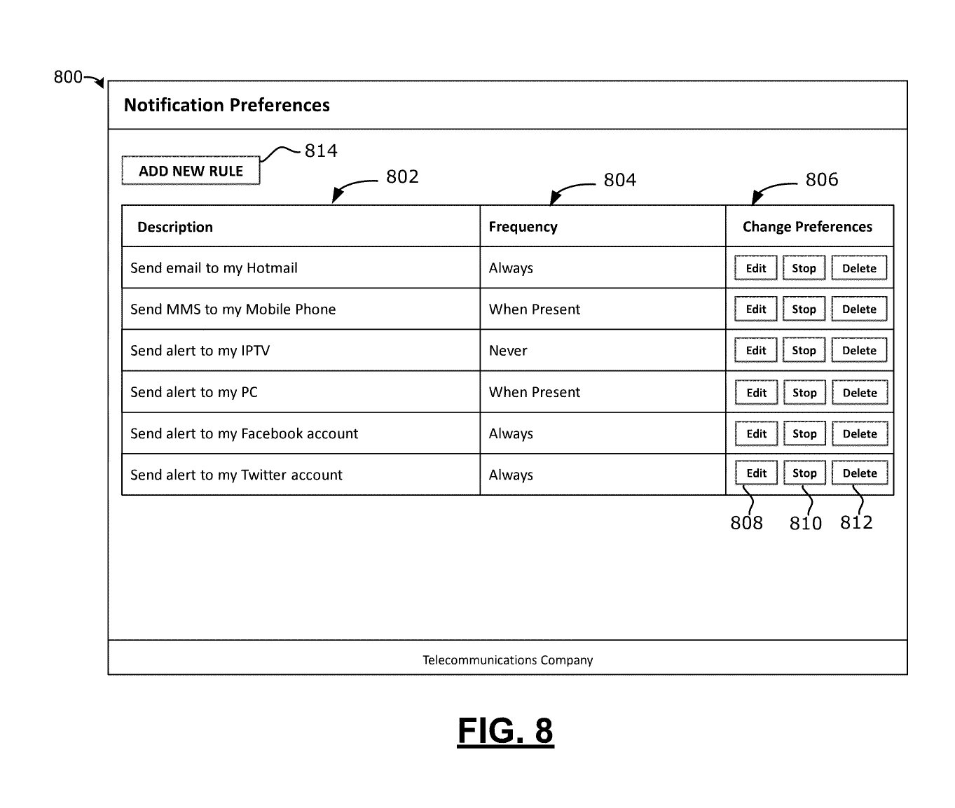

Reference is now made to FIG. 8, which shows an example graphical user interface (GUI) 800 as displayed on the computer device 114 for configuring of alarm notification settings. The interface 800 may be accessible from a web browser in some example embodiments. The interface 800 permits a user to preselect the client applications 210 which are to receive alarm notifications when “present”. The user may also configure other preferences of the client applications 210, such as “always” notify or “never” notify.

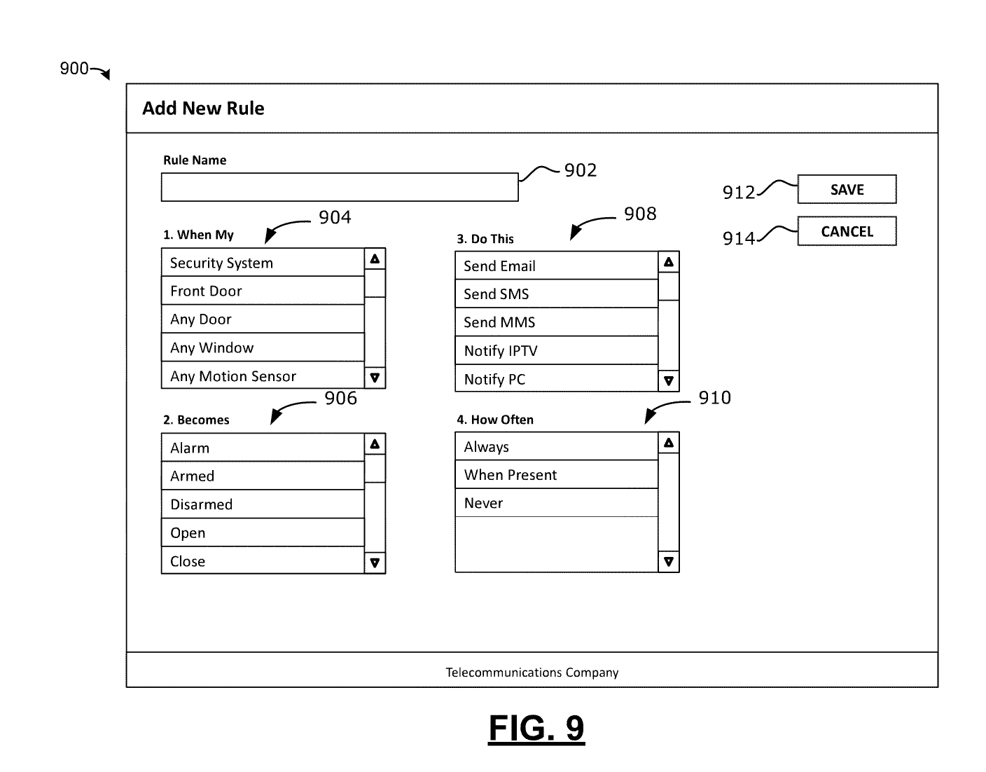

Referring still to FIG. 8, the interface 800 includes a Description 802 of the client application 210, an indication of notification preferences 804, and selectable icons for Change preferences 806. The notification preferences 804 can be “Always”, “When present”, and “Never”, as shown. As shown, the Change preferences 806 include Edit 808, Stop 810, and Delete 812 with respect to a particular client application 210. Any changes to notification settings made using the Change preferences 806 may be saved or updated into the policy database 125 (FIG. 1). A selectable Add New Rule icon 814 may be used to configure a new notification rule, for example as shown in FIG. 9.

Reference is now made to FIG. 9, which shows an example graphical user interface (GUI) 900 as displayed on the computer device 114 for adding of a new notification setting, in accordance with an example embodiment. The interface 900 may be accessible from a web browser in some example embodiments. The interface 900 may include a number of fields or user-selectable fields. As shown, the interface 900 includes a Rule Name field 902 which can be populated (or left blank and automatically populated based no the user selection. The interface 900 also includes user-selectable fields of an on-premises monitoring device 904, an alarm event 906, a selection of a client application 908, and notification preferences 910. The combination of some or all of the selections results in a new rule. Once some or all of the fields 904, 906, 908, 910 are selected, the save icon 912 may be selected to store the new rule in memory (e.g. into policy database 125, FIG. 1). Otherwise, the potential new rule may be cancelled using the cancel icon 914.

In some example embodiments, each alarm event is associated and grouped into one or more alarm levels. For example, some on-premises monitoring devices and associated alarm events may be given higher priority than others, for example based on severity. By way of example, “Level 1” alarm levels may be given the highest priority, and may be given the status of “Always” notification. “Level 2” alarm levels may be given a status of “When Present” notification. “Level 3” alarm levels may be given a status of “Never” notify (e.g. the user may manually check any Level 3 alarm events using the computer device 114, without notification). In some example embodiments, Level 1 alarm levels may result in always notifying the dispatch system 112 (FIG. 1). Other alarm indicators or levels, and associated notification responses or messages, may be used in example embodiments, without intending to be limiting.

In some example embodiments, time of day and/or day settings may also be used to configure preferred alarm notifications. For example, a door open event may not be considered an alarm event during business hours for a business premises. Similarly, for example, a door open event during weekends (Saturday and Sunday) or a holiday may be considered an alarm event. Other time of day and/or day settings may be implemented in accordance with some example embodiments.

Referring again to FIG. 1, the dispatch system 112 may include a dispatch server (not shown), and one or more telephone operators 130 for telephoning or otherwise contacting services for dispatching emergency vehicles 132 depending on the particular alarm event. The emergency vehicles 132 may include, for example, ambulance, firetruck, and/or policy or security.

Reference to premises herein may include a perimeter, border and/or building (residential or corporate). Some example embodiments may be applied to mobile premises such as a boat, airplane, carrier, vehicle, train, and the like.

While some of the present embodiments are described in terms of methods, a person of ordinary skill in the art will understand that present embodiments are also directed to various apparatus such as a server apparatus including components for performing at least some of the aspects and features of the described methods, be it by way of hardware components, software or any combination of the two, or in any other manner. Moreover, an article of manufacture for use with the apparatus, such as a pre-recorded storage device or other similar non-transitory computer readable medium including program instructions recorded thereon, or a computer data signal carrying computer readable program instructions may direct an apparatus to facilitate the practice of the described methods. It is understood that such apparatus, articles of manufacture, and computer data signals also come within the scope of the present example embodiments.

While some of the above examples have been described as occurring in a particular order, it will be appreciated to persons skilled in the art that some of the messages or steps or processes may be performed in a different order provided that the result of the changed order of any given step will not prevent or impair the occurrence of subsequent steps. Furthermore, some of the messages or steps described above may be removed or combined in other embodiments, and some of the messages or steps described above may be separated into a number of sub-messages or sub-steps in other embodiments. Even further, some or all of the steps of the conversations may be repeated, as necessary. Elements described as methods or steps similarly apply to systems or subcomponents, and vice-versa. Reference to such words as “sending” or “receiving” could be interchanged depending on the perspective of the particular device.

The term “computer readable medium” as used herein includes any medium which can store instructions, program steps, or the like, for use by or execution by a computer or other computing device including, but not limited to: magnetic media, such as a diskette, a disk drive, a magnetic drum, a magneto-optical disk, a magnetic tape, a magnetic core memory, or the like; electronic storage, such as a random access memory (RAM) of any type including static RAM, dynamic RAM, synchronous dynamic RAM (SDRAM), a read-only memory (ROM), a programmable-read-only memory of any type including PROM, EPROM, EEPROM, FLASH, EAROM, a so-called “solid state disk”, other electronic storage of any type including a charge-coupled device (CCD), or magnetic bubble memory, a portable electronic data-carrying card of any type including COMPACT FLASH, SECURE DIGITAL (SD-CARD), MEMORY STICK, and the like; and optical media such as a Compact Disc (CD), Digital Versatile Disc (DVD) or BLU-RAY Disc.

Variations may be made to some example embodiments, which may include combinations and sub-combinations of any of the above. The various embodiments presented above are merely examples and are in no way meant to limit the scope of this disclosure. Variations of the innovations described herein will be apparent to persons of ordinary skill in the art having the benefit of the present disclosure, such variations being within the intended scope of the present disclosure. In particular, features from one or more of the above-described embodiments may be selected to create alternative embodiments comprised of a sub-combination of features which may not be explicitly described above. In addition, features from one or more of the above-described embodiments may be selected and combined to create alternative embodiments comprised of a combination of features which may not be explicitly described above. Features suitable for such combinations and sub-combinations would be readily apparent to persons skilled in the art upon review of the present disclosure as a whole. The subject matter described herein intends to cover and embrace all suitable changes in technology.

What is claimed is:

1. A method for alarm event notification, the method comprising:
receiving in a server system an alarm event in relation to a premises;
determining a presence status of a client application;
generating a message in relation to the alarm event; and
sending the message to the client application having the presence status of being present.

2. The method as claimed in claim 1, wherein the message is generated to include message content which varies in dependence of capabilities of the client application having the presence status of being present.

3. The method as claimed in claim 1, wherein the message is generated to include a media file of the premises in a format which varies in dependence of capabilities of the client application having the presence status of being present.

4. The method as claimed in claim 1, wherein the message is generated to include an address or link to media content in relation to the premises, wherein the media content is in a format which varies in dependence of capabilities of the client application having the presence status of being present.

5. The method as claimed in claim 1, wherein the determining of the presence status further comprises determining the presence status of a client device having the client application.

6. The method as claimed in claim 1, wherein the message is sent over a communication medium, wherein the communication medium includes a cable television network.

7. The method as claimed in claim 1, wherein the determining of the presence status includes sending a request for the presence status from the client application without sending alarm information.

8. The method as claimed in claim 1, wherein the client application is selected from a set of preselected client applications which are to receive alarm events when having a presence status of being present.

9. The method as claimed in claim 1, wherein the client application is an application for a social media application, wherein the message is sent over the Internet.

10. The method as claimed in claim 1, wherein the client application is used to display digital television content.

11. The method as claimed in claim 1, wherein the client application is a short messaging application of a wireless communication device, wherein the message is sent over a wireless network.

12. A server system, comprising:
a processor;
memory; and
a communication subsystem for sending and receiving communications,
the processor being configured for:
receiving in a server system an alarm event in relation to a premises,
determining a presence status of a client application,
generating a message in relation to the alarm event, and
sending the message to the client application having the presence status of being present.

13. The server system as claimed in claim 12, wherein the message is generated to include message content which varies in dependence of capabilities of the client application having the presence status of being present.

14. The server system as claimed in claim 12, wherein the message is generated to include a media file of the premises in a format which varies in dependence of capabilities of the client application having the presence status of being present.

15. The server system as claimed in claim 12, wherein the message is generated to include an address or link to media content in relation to the premises, wherein the media content is in a format which varies in dependence of capabilities of the client application having the presence status of being present.

16. The server system as claimed in claim 12, wherein the determining of the presence status further includes determining the presence status of a client device having the client application.

17. The server system as claimed in claim 12, wherein the message is sent over a communication medium, wherein the communication medium includes a cable television network.

18. The server system as claimed in claim 12, wherein the determining of the presence status includes sending a request for the presence status from the client application without sending alarm information.

19. The server system as claimed in claim 12, wherein the client application is selected from a set of preselected client applications which are to receive alarm events when having a presence status of being present.

20. The server system as claimed in claim 12, wherein the client application is an application for a social media application, wherein the message is sent over the Internet.

21. The server system as claimed in claim 12, wherein the client application is used to display digital television content.

22. The server system as claimed in claim 12, wherein the client application is a short messaging application of a wireless communication device, wherein the message is sent over a wireless network.

23. A method for alarm event notification, the method comprising:
receiving in a server system an alarm event in relation to a premises;
determining a presence status of each of a plurality of client applications; and
sending one or more messages in relation to the alarm event, each message being sent to one or more of the client applications having the presence status of being present.

24. The method as claimed in claim 23, wherein the plurality of client applications are selected from a set of preselected client applications which are to receive alarm events when having a presence status of being present.
